(19) United States
(12) Patent Application Publication
(10) Pub. No.: US 2007/0162916 A1
(43) Pub. Date: Jul. 12, 2007

(54) RECORDING AND/OR REPRODUCING DEVICE

(75) Inventor: Kiyoshi Omori, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Minato-Ku (JP)

(21) Appl. No.: 11/617,192

(22) Filed: Dec. 28, 2006

(30) Foreign Application Priority Data
Jan. 12, 2006 (JP) 2006-005287

(51) Int. Cl. G11B 17/04; G11B 33/02

(52) U.S. Cl. 720/601; 720/609

(57) ABSTRACT

A recording/reproducing device includes a disc tray, a device body supporting the disc tray movably in an insertion-ejection direction, and a holding mechanism for holding the disc tray within the device body. The holding mechanism includes a bias member biasing the disc tray outward of the device body, an engagement pin extending through an opening of the device body near a sidewall thereof and engageable with the disc tray to hold the disc tray within the device body, and an engagement segment provided in the disc tray and engageable with the engagement pin. The engagement pin includes a flange portion fitted to a depressed portion of the opening, a pin body extending through the opening, and an engagement projection projected into the device body from the pin body and engageable with the engagement segment. The engagement projection is disposed on the pin body at a position biased towards the sidewall.

### CROSS REFERENCES TO RELATED APPLICATIONS

The present invention contains subject matter related to Japanese Patent Application JP 2006-005287 filed in the Japanese Patent Office on Jan. 12, 2006, the entire contents of which are incorporated herein by reference.

### BACKGROUND OF THE INVENTION

1. Field of the Invention

The present invention relates to a device for recording an information signal onto and/or reproducing an information signal from a disc-shaped recording medium, and particularly, to a mechanism for engaging a disc tray that holds the disc-shaped recording medium to a device body.

2. Description of the Related Art

Portable electronic apparatuses, such as notebook-size personal computers, have become highly functional and are equipped with CD-R/RW or DVD-R/RW drives. In these drives, a higher reading speed, a higher writing speed, and an additional function for rewriting on DVDs are in demand.

In addition to high functionality, since it is more practical that notebook-size personal computers are B5-sized rather than A4-sized in view of portability, notebook-size personal computers have been designed to achieve less thickness and weight. For this reason, CD-R/RW or DVD-R-RW drive devices are preferably reduced in thickness as much as possible.

FIG. 13 illustrates an example of a drive device that records data on or reproduces data from a CD-R/RW or a DVD-R/RW. A drive device 300 of this type includes a device body 301, a disc tray 303 that can accommodate an optical disc 302, such as a DVD, and is movable into or out of the device body 301, and an optical pickup unit 304 which is stored in the disc tray 303 from the underside thereof and reproduces an information signal from the optical disc 302.

The optical pickup unit 304 includes an iron base chassis 315 having a disc table 313 mounted thereto, and a pickup base 317 provided with an objective lens 312.

A surface of the optical pickup unit 304 proximate to the held face of the optical disc 302 has a cover member 320 attached thereto with, for example, screws. The cover member 320 has an aperture 321 through which the objective lens 312 and the disc table 313 in the optical pickup unit 304 are exposed. The bottom surface of the optical pickup unit 304 is provided with a metallic bottom plate 322. This bottom plate 322 is screwed onto a storage portion 325 provided on the underside of the disc tray 303, whereby the optical pickup unit 304 is sandwiched between the bottom plate 322 and the disc tray 303.

The disc tray 303 has a substantially rectangular tray body 305 whose main surface 305a has a holding recess 310 in which the optical disc 302 can be held in place. The storage portion 325 for storing the optical pickup unit 304 is disposed on the underside of the tray body 305. The optical pickup unit 304 having the cover member 320 attached thereto is stored within this storage portion 325. Furthermore, the holding recess 310 has an aperture 311 through which the cover member 320 is exposed. Thus, the cover member 320 constitutes a part of the holding recess 310. Moreover, the objective lens 312 and the disc table 313 for rotatably holding the optical disc 302, which are included in the optical pickup unit 304, are exposed through the aperture 321 of the cover member 320.

Referring to FIG. 14, the storage portion 325 for the optical pickup unit 304 disposed on the underside of the disc tray 303 is provided with a holding mechanism 330 for holding the disc tray 303 within the device body 301. The holding mechanism 330 includes a bias mechanism 331 that biases the disc tray 303 outward of the device body 301 and an engagement mechanism 332 which is engageable with an engagement pin 326 protruding from a lower half component of the device body 301 so that the disc tray 303 can engage with the device body 301.

The bias mechanism 331 includes a pushing member 335 which abuts on a back wall 301a of the device body 301 to push the disc tray 303 outward from the device body 301, and a coil spring 336 that applies a bias force to the pushing member 335 towards the back wall 301a.

The pushing member 335 is substantially rod-shaped. A midsection of the pushing member 335 in the longitudinal direction thereof is provided with a flange 335a. Moreover, the pushing member 335 is disposed within a container portion 338 of the disc tray 303. The container portion 338 extends near a side surface of the disc tray 303 in the insertion-ejection direction of the disc tray 303. The container portion 338 has a through hole 338a provided in a back face 303a of the disc tray 303. The container portion 338 also has a retaining step 338b at a substantially midsection thereof. The flange 335a of the pushing member 335 is retained by this retaining step 338b. Furthermore, the container portion 338 also has a retaining wall 339 which is disposed further towards a front face 303b of the disc tray 303 with respect to the position of the retaining step 338b. As will be described later, one end of the coil spring 336 is retained by this retaining wall 339. The retaining wall 339 has an insertion hole through which the pushing member 335 extends. Moreover, the front face 303b side of the retaining wall 339 is provided with an insertion section 340 for the pushing member 335.

The coil spring 336 is disposed between the retaining step 338b of the container portion 338 and the retaining wall 339. Furthermore, a hollow section of the coil spring 336 has the pushing member 335 extending therethrough. The coil spring 336 has its one end retained by the flange 335a of the pushing member 335 and its other end retained by the retaining wall 339.

According to the bias mechanism 331, the coil spring 336 biases the flange 335a of the pushing member 335 towards the back face 303a so that the pushing member 335 protrudes from the back face 303a, as shown in FIG. 14. In this case, the flange 335a of the pushing member 335 is retained by the retaining step 338b of the container portion 338.

Subsequently, when the disc tray 303 is inserted into the device body 301, the pushing member 335 protruding from the disc tray 303 abuts on the back wall 301a of the device body 301 and is pushed back towards the front face 303b of the disc tray 303 against the bias force of the coil spring 336. Thus, the coil spring 336 is compressed towards the front face 303b due to a pushing force from the flange 335a of the pushing member 335. When the disc tray 303 becomes engaged with the device body 301 by the engagement mechanism 332, the coil spring 336 is in a state where its bias force that biases the pushing member 335 towards the back face 303a is maintained, as shown in FIG. 15. In this case, the pushing member 335 extends through the insertion hole in the retaining wall 339 and into the insertion section 340.

Subsequently, when the disc tray 303 becomes disengaged from the device body 301 by the engagement mechanism 332, the coil spring 336 biases the flange 335a of the pushing member 335 towards the back face 303a. The pushing member 335 thus extends through the through hole 338a and protrudes from the back face 303a of the disc tray 303 so as to abut on the back wall 301a of the device body 301. When the coil spring 336 further biases the pushing member 335, the coil spring 336 begins to expand towards the front face 303b of the disc tray 303 from the flange 335a of the pushing member 335 abutted on the back wall 301a of the device body 301. Consequently, the coil spring 336 biases the retaining wall 339 towards the front face 303b so as to force the disc tray to become ejected from the device body 301.

The engagement mechanism 332 for engaging the disc tray 303 with the device body 301 when the disc tray 303 is inserted into the device body 301 will now be described.

Referring to FIG. 16, the engagement mechanism 332 includes the engagement pin 326 provided in the device body 301 and engageable with the disc tray 303 such as to hold the disc tray 303 within the device body 301, and an engagement segment 341 provided in the disc tray 303 and rotatably biased in a direction for engaging with the engagement pin 326.

Referring to FIG. 13, the engagement pin 326 protrudes from a position near one side surface of the lower half component of the device body 301. The engagement pin 326 is substantially columnar, and when the disc tray 303 is inserted into the device body 301, the engagement pin 326 engages with the engagement segment 341 included in the disc tray 303, thereby holding the disc tray 303 within the device body 301.

Referring to FIG. 16, the engagement segment 341 engageable with the engagement pin 326 includes a hook-shaped engaging portion 342 that engages with the engagement pin 326, a trunk portion 343 having the engaging portion 342 at a tip end thereof, a fulcrum portion 344 disposed at a base end of the trunk portion 343 and serving as a fulcrum for the engagement segment 341, and an operating portion 346 which is in contact with an eject button 345 and is for rotating the engagement segment 341. The engagement segment 341 is rotatable about the fulcrum portion 344 in a direction indicated by an arrow D in FIG. 16 or in the opposite direction of the arrow D. Moreover, a torsion spring 347 is wound around the fulcrum portion 344 such that the engagement segment 341 is constantly biased in the rotational direction of the arrow D. When the engagement segment 341 rotates in the direction of the arrow D in FIG. 16, the engaging portion 342 is positioned on a traveling path of the engagement pin 326 provided in the device body 301.

The eject button 345 in contact with the operating portion 346 is provided on, for example, an operation panel (not shown) disposed on a front face 301b of the device body 301. When the disc tray 303 is to be ejected, a user operates the eject button 345 to push the operating portion 346, thereby rotating the engagement segment 341 in the opposite direction of the arrow D in FIG. 16.

The engagement segment 341 also has a slope surface 343a which extends from the tip end of the trunk portion 343 in the direction of the arrow D and in the traveling direction of the engagement pin 326. The extending end of the slope surface 343a has the hook-shaped engaging portion 342. Furthermore, the engagement segment 341 has the operating portion 346 disposed opposite to the slope surface 343a across the fulcrum portion 344. The operating portion 346 rotates in the opposite direction of the arrow D in FIG. 16 in response to a pressing force from the eject button 345. When rotated in the direction of the arrow D, the engaging portion 342 engages with the engagement pin 326 such as to hold the disc tray 303 within the device body 301, whereas when rotated in the opposite direction of the arrow D, the engaging portion 342 disengages from the engagement pin 326, whereby the disc tray 303 can be ejected from the device body 301 by the coil spring 336 and the pushing member 335.

In detail, as the disc tray 303 is inserted into the device body 301, the engagement pin 326 in the lower half component of the device body 301 travels in the direction indicated by an arrow H in FIG. 16. The engagement pin 326 then abuts on the slope surface 343a so as to rotate the engagement segment 341 in the opposite direction of the arrow D. When the engagement pin 326 passes over the tip end of the slope surface 343a, the engagement segment 341 rotates in the direction of the arrow D due to the bias force of the torsion spring 347, whereby the engaging portion 342 returns to its position on the traveling path of the engagement pin 326. Thus, the engaging portion 342 of the engagement segment 341 engages with the engagement pin 326, whereby the disc tray 303 and the device body 301 engage with each other. In this case, the engagement segment 341 is in a state where the engaging portion 342 thereof is applying a bias force to the engagement pin 326 due to the bias mechanism 331 provided in the disc tray 303.

When ejecting the disc tray 303 outward from the device body 301, the eject button 345 is operated in order to push the operating portion 346. By pushing the operating portion 346 with the eject button 345, the engagement segment 341 rotates in the opposite direction of the arrow D in FIG. 16. In response to the rotation of the engagement segment 341 in the opposite direction of the arrow D, the engaging portion 342 withdraws from the traveling path of the engagement pin 326 so as to disengage from the engagement pin 326. Accordingly, the disc tray 303 disengages from the device body 301, whereby the disc tray 303 is ejected outward from the device body 301 by the bias mechanism 331.

An example of this drive device is disclosed in Japanese Unexamined Patent Application Publication No. 2004-234800.

### SUMMARY OF THE INVENTION

After the drive device 300 has been assembled, the drive device 300 itself is directly shipped from the manufacturing plant or is installed in a notebook-side personal computer before shipment. During the course of distribution, the drive device 300 is maintained in a state where the engagement segment 341 is kept in engagement with the engagement pin 326 so that the disc tray 303 inserted in the device body 301 is restricted from being ejected therefrom. In case the drive device 300 or the notebook-side personal computer is accidentally dropped in the course of distribution, a packing material is generally used to alleviate the dropping impact to avoid defects such as malfunction. However, depending on the direction of the impact, the engagement pin 326 may receive an excessive load, causing the base end of the engagement pin 326 to become detached from the device body 301 and to tilt.

Specifically, referring to FIGS. 17A and 17B, the engagement pin 326 extends through and is supported by a circular opening 350 in the lower half component of the device body 301. The opening 350 has a step portion 351 which extends around the periphery of the opening 350. The engagement pin 326 includes a flange portion 352 which is retained by the step portion 351 when the engagement pin 326 is inserted into the opening 350 from the underside of the lower half component, a pin body 353 which has the flange portion 352 at the base end thereof and is fitted to the opening 350, and an engagement projection 354 projected from the top of the pin body 353 and engageable with the engagement segment 341 by protruding from the top surface of the lower half component.

If the drive device 300 or the notebook-size personal computer is accidentally dropped and the impact is exerted in the insertion-ejection direction of the disc tray 303, the impact is transmitted to the engagement pin 326 via the engaging portion 342 of the engagement segment 341. This may cause the engagement projection 354 of the engagement pin 326 to tilt, as shown in FIGS. 18 and 19. In addition, the flange portion 352 may become detached from the step portion 351 of the opening 350 such as to protrude from the underside of the lower half component.

For preventing such tilting of the engagement projection 354 and detachment of the flange portion 352, the opening 350 and the flange portion 352 having a disc shape may be given larger diameters.

However, in view of the demands for size reduction in the drive devices 300 and notebook-size personal computers, there is a restriction on the positioning of the engagement mechanism 332 in the disc tray 303. For this reason, the engagement pin 326 should be disposed in the vicinity of one of the sidewalls of the lower half component. Consequently, there is a certain limit to increasing the diameter of the opening 350 in the lower half component or the diameter of the flange portion 352 of the engagement pin 326 in view of the distance relationship with the sidewall. In other words, if the opening 350 is disposed too close to the sidewall, the rigidity of the lower half component will be lost, thus losing the capability to secure the engagement pin 326 tightly.

It is therefore desirable to provide a recording and/or reproducing device equipped with an engagement pin that is highly resistant to a dropping impact.

A recording and/or reproducing device according to an embodiment of the present invention includes a disc tray on which a recording medium is set, a device body that supports the disc tray in a manner such that the disc tray is movable into and out of the device body, and a disc-tray holding mechanism for holding the disc tray within the device body. The disc-tray holding mechanism includes a bias member for biasing the disc tray outward of the device body, an engagement pin extending through an opening of the device body near a sidewall of the device body and being engageable with the disc tray such as to hold the disc tray within the device body, and an engagement segment provided in the disc tray and engaging with the engagement pin when the disc tray is inserted into the device body against a bias force of the bias member. The engagement pin includes a flange portion which is fitted to a depressed portion extending along an inner periphery of the opening, a pin body that extends through the opening, and an engagement projection which is projected from the pin body towards the inside of the device body and is engageable with the engagement segment. The engagement projection is disposed on the pin body at a position biased towards the sidewall of the device body.

Accordingly, in the recording and/or reproducing device according to the embodiment of the present invention, the depressed portion and the flange portion are given enlarged diameters to improve the resistance to dropping impact while a preferred distance is maintained between the engagement pin and the sidewall of the device body. In addition, the engagement projection is allowed to project from a position that corresponds to the engagement segment, which is subject to positional restriction.

### BRIEF DESCRIPTION OF THE DRAWINGS

FIG. 1 is a perspective view of a notebook-size personal computer in which a recording and/or reproducing device according to an embodiment of the present invention is installed;

FIG. 2 is an exploded perspective view of the recording and/or reproducing device according to the embodiment of the present invention;

FIG. 3 is a cross-sectional view of the recording and/or reproducing device according to the embodiment of the present invention;

FIG. 4 is a plan view of a disc tray as viewed from an underside thereof;

FIG. 5 is another plan view of the disc tray as viewed from the underside thereof;

FIG. 6 is a plan view of an engagement mechanism;

FIG. 7 is another plan view of the engagement mechanism;

FIGS. 8A and 8B are a cross-sectional view and a plan view, respectively, which illustrate an engagement pin;

FIGS. 9A and 9B are a cross-sectional view and a plan view, respectively, which illustrate another example of an engagement pin;

FIGS. 10A and 10B are a cross-sectional view and a plan view, respectively, which illustrate another example of an engagement pin;

FIG. 11 is a plan view of an optical pickup unit;

FIG. 12 is a perspective view of the disc tray and a device body supporting the disc tray in a slidable fashion;

FIG. 13 is an exploded perspective view of a drive device in related art;

FIG. 14 is a plan view of a disc tray in the related art, as viewed from an underside thereof;

FIG. 15 is another plan view of the disc tray in the related art, as viewed from the underside thereof;

FIG. 16 is a plan view of an engagement mechanism in the related art;

FIGS. 17A and 17B are a cross-sectional view and a plan view, respectively, which illustrate an engagement pin in the related art;

FIG. 18 is a perspective view showing a condition where an engagement pin in the related art is tilted; and

FIG. 19 is a cross-sectional view showing the tilted condition of the engagement pin in the related art.

### DESCRIPTION OF THE PREFERRED EMBODIMENT

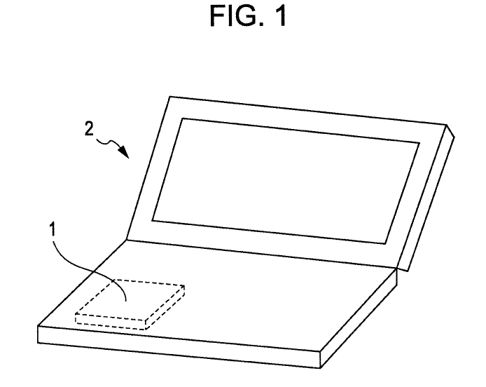

A recording and/or reproducing device according to a preferred embodiment of the present invention, which will be referred to as a recording/reproducing device 1 hereinafter, will be described below with reference to the drawings. The recording/reproducing device 1 is a drive device for recording data onto or reproducing data from an optical disc, such as a compact disc (CD) and a digital versatile disc (DVD). Referring to FIG. 1, the recording/reproducing device 1 is installed in a drive bay of a host apparatus 2, such as a notebook-size personal computer.

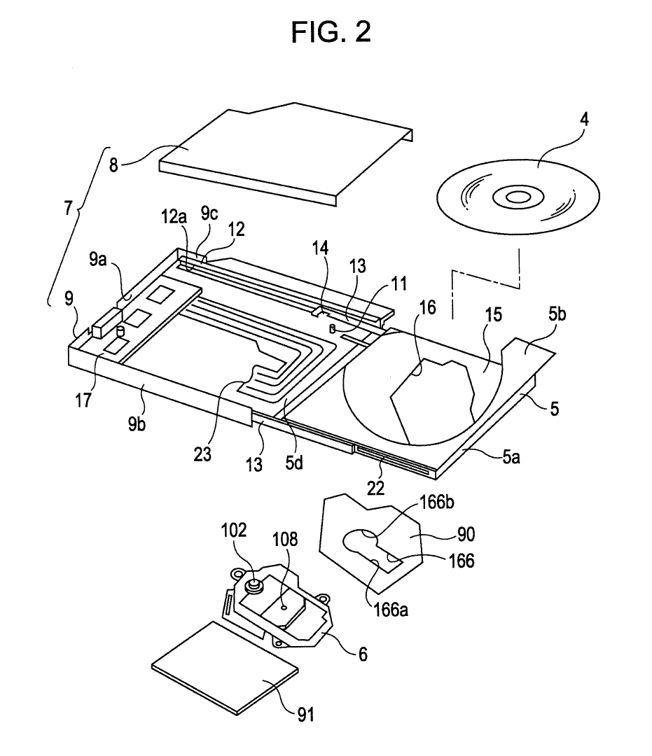

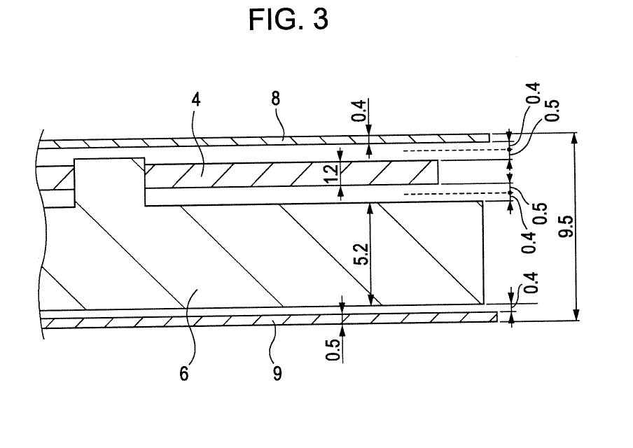

Referring to FIG. 2, the recording/reproducing device 1 includes a disc tray 5 that can accommodate an optical disc 4, such as a DVD, and an optical pickup unit 6 which is joined to the disc tray 5 and reproduces an information signal from the optical disc 4. With the reduction in size and thickness of the host apparatus 2, a device body 7 of the recording/reproducing device 1 is given the same thickness as a hard disc drive in the host apparatus 2, which is about 9.5 mm, as shown in FIG. 3. The 9.5-mm thickness of the device body 7 is a total of a 1.2-mm thickness of the optical disc 4, a ±0.5-mm surface wobble range of the rotating optical disc 4, a 5.2-mm height of the disc tray 5 joined to the optical pickup unit 6, a 0.4-mm clearance gap between the disc-holding surface of the disc tray 5 and the optical disc 4, a 0.4-mm clearance gap between the disc tray 5 and the bottom surface of the device body 7, a 0.4-mm clearance gap between the optical disc 4 and the top surface of the device body 7, and 0.4-mm and 0.5-mm thicknesses of a pair of upper and lower half components 8, 9 that constitute an outer housing of the device body 7.

This device body 7 of the recording/reproducing device 1 is formed by joining together the pair of upper and lower half components 8, 9. The upper and lower half components 8, 9 are each formed by punching a metal plate into a predetermined shape and then machining the metal plate to form, for example, holes.

The lower half component 9 of the device body 7 is provided with a wiring substrate 17 having, for example, connectors for connecting to a control circuit for controlling the driving of the recording/reproducing device 1 and to the host apparatus 2. The lower half component 9 has an open end through which the disc tray 5 can be ejected outward from the device body 7. On the other hand, an end of the lower half component 9 that is opposite to the open end is provided with a back wall 9a. The open end and the back wall 9a have sidewalls 9b, 9c disposed therebetween.

The opposing sidewalls 9b, 9c have guide rails 12 extending between the back wall 9a and the open end. The guide rails 12 guide the disc tray 5 when the disc tray 5 is being inserted into or ejected from the device body 7. Each of the guide rails 12 is substantially U-shaped in cross section. Specifically, each guide rail 12 has a U-shaped recess 12a and is disposed such that the U-shaped recess 12a faces the interior of the device body 7. Guide members 13 joined to the disc tray 5 are slidably engaged with these recesses 12a of the guide rails 12. Moreover, the guide rails 12 are provided with stopper segments 14 for regulating the sliding range of the guide members 13 in order to prevent the disc tray 5 from being ejected by more than a predetermined length from the device body 7.

The guide members 13 engaged with the guide rails 12 are substantially U-shaped in cross section and hold the opposite side surfaces of the disc tray 5 from opposite directions. When the disc tray 5 is being inserted into or ejected from the device body 7, the guide members 13 slide along the guide rails 12 so as to smoothly guide the moving disc tray 5.

Furthermore, the lower half component 9 has an engagement pin 11 which engages with a holding mechanism 18 that holds the disc tray 5 within the device body 7. The wiring substrate 17 having a drive circuit is disposed near the back wall 9a of the lower half component 9. The wiring substrate 17 is a so-called rigid substrate provided with a wiring pattern and having mounted thereon various types of electronic parts, such as connectors, for connecting to external devices. Moreover, the wiring substrate 17 has an FPC (flexible printed circuit) 23 attached thereto, which is connected to the optical pickup unit 6.

The disc tray 5 to be inserted into or ejected from the device body 7 has a holding recess 15 in which the optical disc 4 can be held in place. The holding recess 15 is substantially circular and its main surface has an aperture 16. Through this aperture 16, a disc table 102 and an objective lens 108 of the optical pickup unit 6 stored in the disc tray 5 can face the optical disc 4. The aperture 16 extends from substantially the center of the holding recess 15 towards a front face 5a of the disc tray 5. Through the aperture 16, a cover member 90 attached to a base chassis 101 of the optical pickup unit 6 and the disc table 102 and the objective lens 108 attached to the base chassis 101 and facing upward through the cover member 90 are allowed to face the optical disc 4.

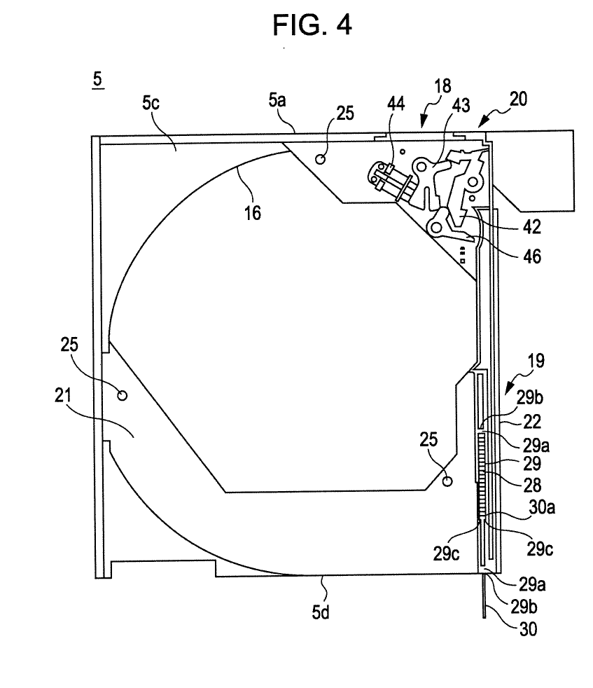

The disc tray 5 is composed of a rigid material of PPE (polyphenylether) containing 20% of glass. The substantially circular holding recess 15 in which the optical disc 4 can be held in place is provided on a main surface 5b of the disc tray 5. Furthermore, referring to FIG. 4, a storage portion 21 for storing the optical pickup unit 6 and the holding mechanism 18 for holding the disc tray 5 within the device body 7 are provided on an undersurface 5c of the disc tray 5.

The storage portion 21 has a plurality of engagement protrusions 25 that are to be engaged with the optical pickup unit 6. The storage portion 21 is joined to the optical pickup unit 6 by engaging the engagement protrusions 25 with a plurality of engagement holes 111 provided in the base chassis 101 of the optical pickup unit 6.

The disc tray 5 has protruding ribs 22 that are engaged with the guide members 13 and extend in the insertion-ejection direction with respect to the device body 7. The protruding ribs 22 are held slidably by the guide members 13 from opposite directions and are guided by the guide members 13 for the insertion and ejection of the disc tray 5 with respect to the device body 7. Furthermore, each of the protruding ribs 22 has stopper segments, one stopper segment being disposed at an end proximate to a back face 5d of the disc tray 5, that is, an end closer to the device body 7 when the disc tray 5 is in an ejected state, and another stopper segment being disposed at an end proximate to the front face 5a as viewed in the ejection direction of the disc tray 5. The stopper segments prevent the protruding ribs 22 from disengaging from the guide members 13 and also prevent the guide members 13 from protruding outward from the front face 5a.

As mentioned above, the disc tray 5 is provided with the holding mechanism 18 for holding the disc tray 5 within the device body 7. The holding mechanism 18 is disposed near one edge of the undersurface 5c of the disc tray 5 and includes a bias mechanism 19 for biasing the disc tray 5 outward of the device body 7 and an engagement mechanism 20 for engaging the disc tray 5 within the device body 7.

The bias mechanism 19 for biasing the disc tray 5 outward of the device body 7 will be described first.

Referring to FIG. 4, the bias mechanism 19 is disposed on the undersurface 5c of the disc tray 5 and has a coil spring 28 for pushing the disc tray 5 outward from the device body 7. The coil spring 28 is housed in a spring container 29 extending along one of the protruding ribs 22 in the insertion-ejection direction of the disc tray 5. A hollow section of the coil spring 28 has a rod-shaped pushing member 30 extending therethrough. The pushing member 30 can be inserted through insertion holes 29b provided in container walls 29a at the back face 5d side and the front face 5a side of the spring container 29. Moreover, a midsection of the pushing member 30 in the longitudinal direction thereof is provided with a flange 30a. One end of the coil spring 28 pushes against one surface of the flange 30a so as to bias the pushing member 30 towards the back face 5d. On the other hand, the other surface of the flange 30a is retained by a step 29c provided at the back face 5d side of the spring container 29. In this case, a section of the pushing member 30 that extends from the flange 30a towards the back face 5d protrudes toward the device body 7 by passing through the insertion hole 29b in the corresponding container wall 29a of the spring container 29.

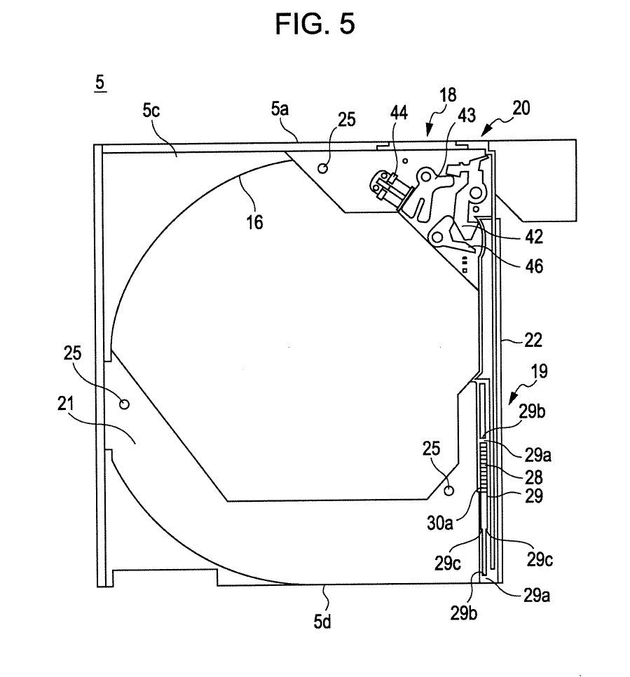

When the disc tray 5 is inserted into the device body 7, this section of the pushing member 30 protruding towards the device body 7 abuts on the back wall 9a of the lower half component 9. Furthermore, referring to FIG. 5, when the disc tray 5 is in an inserted state, the pushing member 30 is pushed back by the back wall 9a and thus moves toward the front face 5a. As a result, the flange 30a compresses the coil spring 28 towards the front face 5a. In this case, since the end of the coil spring 28 proximate to the front face 5a is retained by the corresponding container wall 29a of the spring container 29, the coil spring 28 is compressed due to the pressure from the flange 30a, whereby a bias force that biases the flange 30a towards the back face 5d is maintained. Subsequently, when the engagement mechanism 20 included in the disc tray 5 engages the disc tray 5 within the device body 7, this state in which the bias force of the coil spring 28 biases the flange 30a towards the back face 5d is maintained.

When the engaged state of the disc tray 5 is released by the engagement mechanism 20, the pushing member 30 biased by the coil spring 28 receives a reactive force from the back wall 9a, which is equal to the bias force of the coil spring 28. As a result, the coil spring 28 is pushed back towards the front face 5a by the flange 30a. In this case, since the end of the coil spring 28 proximate to the front face 5a is retained by the corresponding container wall 29a of the spring container 29, the coil spring 28 expands while pushing the container wall 29a towards the front face 5a. Thus, the disc tray 5 is pushed towards the open end of the device body 7 until the front face 5a protrudes outward from the open end of the device body 7, whereby the disc tray 5 can be pulled out. Referring to FIG. 4, because the flange 30a of the pushing member 30 is biased towards the back face 5d by the coil spring 28, the section of the pushing member 30 that extends from the flange 30a towards the back face 5d protrudes toward the device body 7 by passing through the insertion hole 29b in the corresponding container wall 29a of the spring container 29.

The engagement mechanism 20 for engaging the disc tray 5 within the device body 7 will now be described. Referring to FIGS. 4 to 7, the engagement mechanism 20 includes the engagement pin 11 which is provided in the device body 7 and is engageable with the disc tray 5 such as to engage the disc tray 5 within the device body 7, an engagement segment 42 provided in the disc tray 5 and rotatably biased in a direction for engaging with the engagement pin 11, a rotatable segment 43 which regulates the rotating range of the engagement segment 42 by being in contact with the engagement segment 42 so as to engage or disengage the engagement segment 42 to or from the engagement pin 11, a plunger 45 extending through an iron-core coil 44 and connected to the rotatable segment 43 such as to rotate the rotatable segment 43, and a pushing segment 46 which comes into contact with the rotatable segment 43 in response to a pushing force from the engagement pin 11 and pushes the rotatable segment 43 in a direction for engaging the engagement segment 42 with the engagement pin 11.

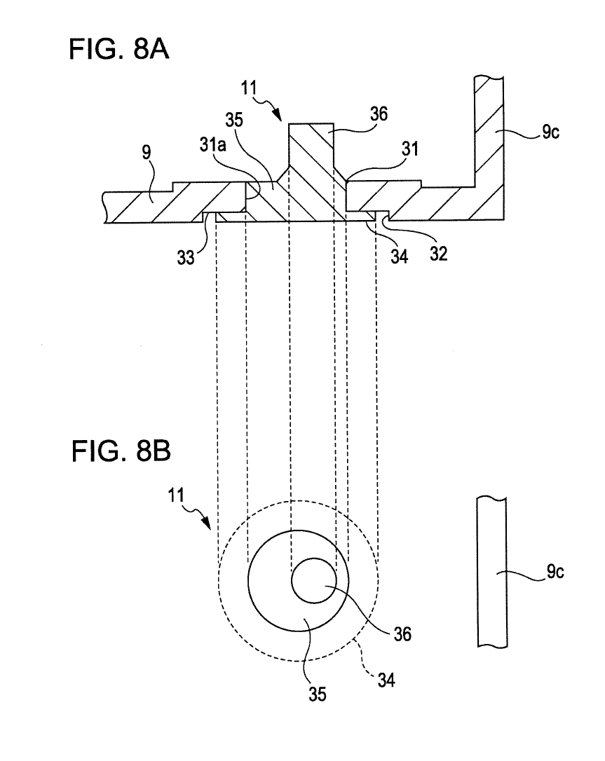

Referring to FIG. 2, the engagement pin 11 is provided in the lower half component 9 and is disposed near the open-end side of the guide rails 12. When the disc tray 5 is inserted into the device body 7, the engagement pin 11 engages with the engagement segment 42 provided on the disc tray 5 so as to hold the disc tray 5 within the device body 7. In detail, referring to FIGS. 8A and 8B, the engagement pin 11 extends through and is supported by an opening 31 provided in the lower half component 9 of the device body 7.

The opening 31 in the lower half component 9 is disposed near the open-end side of the sidewall 9c having the corresponding guide rail 12. More specifically, the opening 31 is disposed at a position corresponding to an engagement position between the engagement pin 11 and the engagement segment 42. The opening 31 is, for example, circular, and includes a depressed portion 33 that surrounds the opening 31 on the underside of the lower half component 9. This depressed portion 33 is defined by a step portion 32 which extends around the periphery of the opening 31 on the underside of the lower half component 9. The engagement pin 11 is retained by this depressed portion 33. In addition to the depressed portion 33, the opening 31 also includes a hole portion 31a in substantially the center of the depressed portion 33. The engagement pin 11 can be fitted to this hole portion 31a.

The engagement pin 11 includes a flange portion 34 which is retained by the depressed portion 33 of the opening 31 when the engagement pin 11 is inserted into the opening 31 from the underside of the lower half component 9, a pin body 35 which has the flange portion 34 at the base end thereof and is fitted to the hole portion 31a, and an engagement projection 36 projected from the top of the pin body 35 and engageable with the engagement segment 42 by protruding from the top surface of the lower half component 9. The pin body 35 is a columnar body that has substantially the same diameter as the hole portion 31a of the opening 31. The flange portion 34 at the base end of the pin body 35 is given a disc shape in correspondence to the depressed portion 33. The engagement projection 36 projected from the top of the pin body 35 is a columnar body having a diameter smaller than that of the pin body 35.

The engagement pin 11 is inserted into the opening 31 from the underside of the lower half component 9. In this case, the flange portion 34 of the engagement pin 11 is retained by the depressed portion 33, the pin body 35 extends through the hole portion 31a, and the engagement projection 36 protrudes from the top surface of the lower half component 9. In this state, the flange portion 34 is substantially flush with the undersurface of the lower half component 9 due to the step portion 32 of the opening 31.

The opening 31 and the engagement pin 11 are given dimensions that achieve a sufficient resistance to an impact transmitted via the engagement segment 42 when the recording/reproducing device 1 is dropped in a state where the engagement projection 36 is engaged with the engagement segment 42. In other words, referring to FIGS. 8A and 8B, by giving the depressed portion 33 of the opening 31 and the flange portion 34 of the engagement pin 11 large diameters, the flange portion 34 can be increased in size in the sliding direction of the disc tray 5, which is a direction in which the impact is transmitted to the engagement pin 11 through the engagement segment 42. Accordingly, this achieves an improved resistance to dropping impact.

Generally, when the recording/reproducing device 1 or a notebook-size personal computer containing the recording/reproducing device 1 is being carried, the disc tray 5 is stored within the device body 7 and the engagement segment 42 provided in the disc tray 5 is engaged with the engagement pin 11 provided in the device body 7. Therefore, if the recording/reproducing device 1 or the notebook-size computer is accidentally dropped during the carrying process, for example, the dropping impact will be transmitted to the engagement pin 11 through the engagement segment 42. Since the disc tray 5 has the optical pickup unit 6 attached thereto, the disc tray 5 has a relatively large weight, which implies that a strong impact generated as a result of the dropping of the disc tray 5 is exerted on the engagement pin 11. Specifically, this impact is exerted on the engagement pin 11 in the sliding direction of the disc tray 5 via a contact between the engagement projection 36 and an engaging portion 48 of the engagement segment 42.

When this dropping impact is transmitted from the engagement projection 36 to the flange portion 34, the impact may generally cause the flange portion 34 fitted to the depressed portion 33 of the opening 31 to become detached from the depressed portion 33, thus causing the engagement pin 11 to tilt. However, according to this embodiment of the present invention, a large contact area is provided between the flange portion 34 of the engagement pin 11 and the depressed portion 33 of the opening 31 in the sliding direction of the disc tray 5 so as to achieve an improved resistance to a dropping impact transmitted through the engagement segment 42 provided in the disc tray 5.

Due to demands for size reduction in recording/reproducing devices 1 and notebook-size personal computers containing recording/reproducing devices 1, there is a restriction on the positioning of the engagement mechanism 20 in the disc tray 5. For this reason, the engagement pin 11 should be disposed in the vicinity of the sidewall 9c of the lower half component 9. Consequently, there is a certain limit to increasing the diameter of the depressed portion 33 of the opening 31 in the lower half component 9 or the diameter of the flange portion 34 of the engagement pin 11 in view of the distance relationship with the sidewall 9c. In other words, if the depressed portion 33 of the opening 31 is supposedly disposed too close to the sidewall 9c, the rigidity of the lower half component 9 may be lost, thus losing the capability to secure the engagement pin 11 tightly. On the other hand, the side opposite to the sidewall 9c has no impediments and provides a sufficient space for the opening 31 and the engagement pin 11.

Accordingly, in the recording/reproducing device 1 according to this embodiment of the present invention, the opening 31 given a sufficient diameter for attaining the desired resistance to dropping impact is disposed at a position that is separated from the sidewall 9c by a preferred distance, and moreover, the engagement projection 36 of the engagement pin 11 is disposed on the pin body 35 at a position biased towards the sidewall 9c in correspondence to the engagement segment 42. In detail, the opening 31 includes the annular depressed portion 33 and the circular hole portion 31a. Furthermore, the engagement pin 11 has the disc-shaped flange portion 34 at the base end of the columnar pin body 35, and moreover, the top end of the pin body 35, which is opposite to the end with the flange portion 34, has the columnar engagement projection 36 projected from a position that is biased towards the sidewall 9c from the center of the top of the pin body 35. The depressed portion 33 of the opening 31 and the flange portion 34 of the engagement pin 11 are both given diameters that can attain a sufficient contact area for achieving the desired resistance to dropping impact. By inserting the engagement pin 11 into the opening 31, the flange portion 34 with the enlarged diameter is retained by the depressed portion 33 of the opening 31 also given an enlarged diameter. As a result, the pin body 35 extends through the hole portion 31a, and the engagement projection 36 is projected from a position near the sidewall 9c. Consequently, in the recording/reproducing device 1, the depressed portion 33 and the flange portion 34 are given enlarged diameters to improve the resistance to dropping impact while a preferred distance is maintained between the engagement pin 11 and the sidewall 9c. In addition, the engagement projection 36 is allowed to project from a position that corresponds to the engagement segment 42, which is subject to positional restriction.

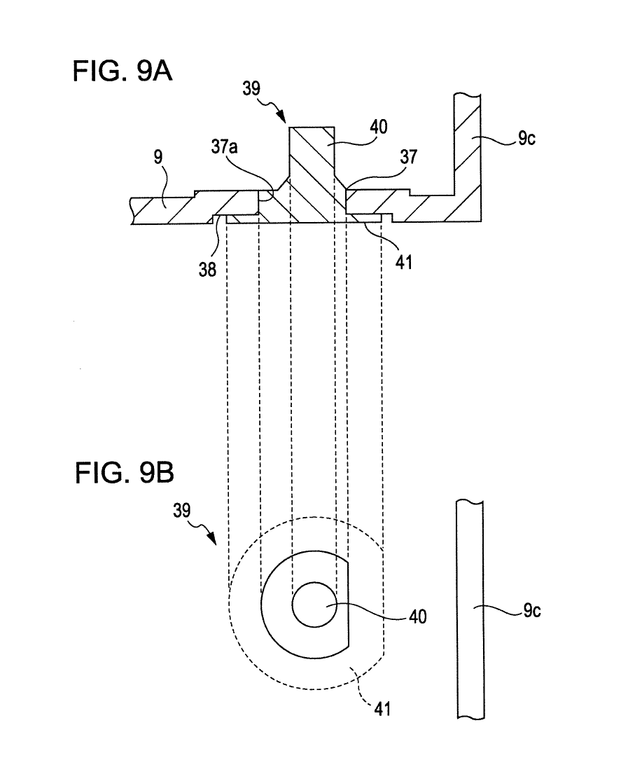

As an alternative to the circular flange portion 34 and the circular depressed portion 33, the flange portion of engagement pin 11 and the depressed portion of the opening 31 may be substantially D-shaped as shown in FIGS. 9A and 9B, where the cutaway side of the D shape is proximate to the sidewall 9c. An opening 37 shown in FIGS. 9A and 9B includes a substantially D-shaped depressed portion 38 whose contact area with a flange portion 41 is sufficient for attaining the desired resistance to a dropping impact of the recording/reproducing device 1. The opening 37 also includes a hole portion 37a through which an engagement pin 39 can extend. The hole portion 37a is positioned concentrically to the depressed portion 38, supposing that the depressed portion 38 is circular.

The engagement pin 39 shown in FIGS. 9A and 9B includes a substantially D-shaped pin body formed by cutting away a side of a columnar body that is proximate to the sidewall 9c, and the substantially D-shaped flange portion 41 at the base end of the pin body. Similar to the depressed portion 38, the cutaway side of the substantially D-shaped flange portion 41 is proximate to the sidewall 9c. Supposing that the flange portion 41 is circular and the pin body is columnar, the flange portion 41 of the engagement pin 39 is concentric to the pin body. Furthermore, when the flange portion 41 is retained by the depressed portion 38, the flange portion 41 has a sufficient surface area for achieving the desired resistance to a dropping impact of the recording/reproducing device 1. On the top of the pin body is provided an engagement projection 40 concentric to the pin body. The engagement projection 40 is a columnar body having a diameter smaller than that of the pin body. In plan view, the engagement projection 40 is disposed on the D-shaped pin body at a position biased towards the cutaway side of the D-shaped pin body.

When the engagement pin 39 is inserted into the opening 37, the flange portion 41 is retained by the depressed portion 38. As a result, the pin body extends through the hole portion 37a, and the engagement projection 40 is projected from a position near the sidewall 9c. With the engagement pin 39 and the opening 37 shown in FIGS. 9A and 9B, the recording/reproducing device 1 can similarly allow the depressed portion 38 and the flange portion 41 to have enlarged diameters to improve the resistance to dropping impact while still maintaining a preferred distance between the engagement pin 39 and the sidewall 9c. In addition, the engagement projection 40 is allowed to project from a position that corresponds to the engagement segment 42, which is subject to positional restriction. Furthermore, in the configuration shown in FIGS. 9A and 9B, since the depressed portion 38, the flange portion 41, and the engagement projection 40 are disposed concentrically to each other, the flange portion 41 and the depressed portion 38 can be increased in size in the sliding direction of the disc tray 5, which is the direction in which an impact is transmitted to the engagement projection 40. Accordingly, this achieves an improved resistance to dropping impact.

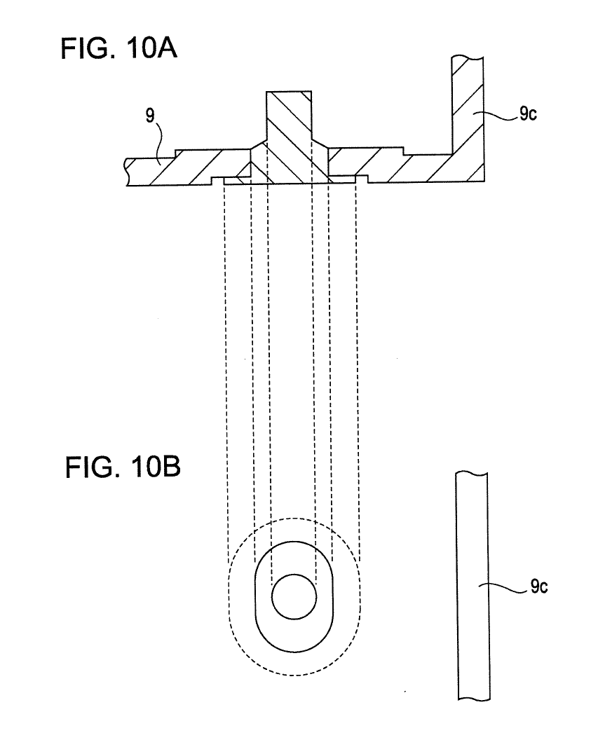

Alternatively, the engagement pin, the opening, the depressed portion, and the flange portion may each have its sidewall 9c side and its side opposite to the sidewall 9c cut away as shown in FIGS. 10A and 10B such as to be given a substantially oval shape. According to the configuration shown in FIGS. 10A and 10B, the flange portion and the depressed portion can be increased in size in the sliding direction of the disc tray 5, which is the direction in which an impact is transmitted to the engagement projection, thereby achieving an improved resistance to dropping impact.

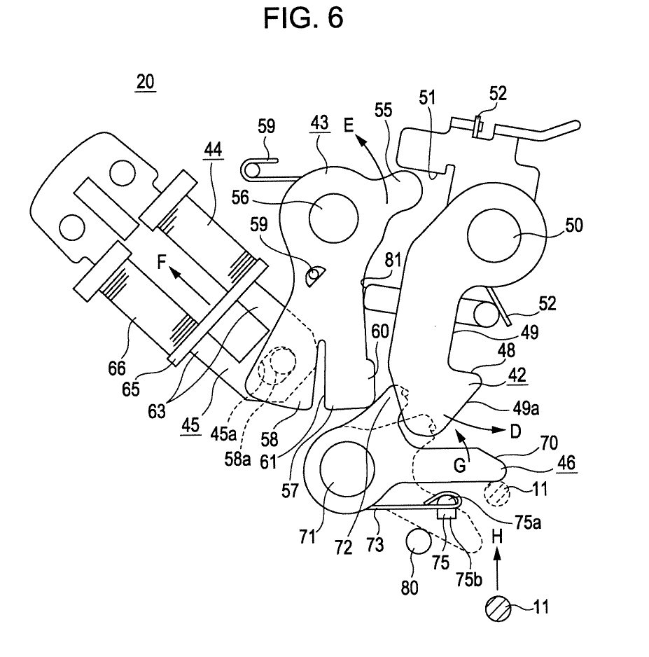

Referring to FIG. 6, the engagement segment 42 engageable with the engagement pin 11 includes the hook-shaped engaging portion 48 that engages with the engagement pin 11, a trunk portion 49 having the engaging portion 48 at a tip end thereof, a fulcrum portion 50 disposed at a base end of the trunk portion 49 and serving as a fulcrum for the engagement segment 42, and a contact portion 51 which is in contact with the rotatable segment 43. The engagement segment 42 is rotatable about the fulcrum portion 50 in the direction indicated by an arrow D in FIG. 6 or in the opposite direction of the arrow D. Moreover, a torsion spring 52 is wound around the fulcrum portion 50 such that the engagement segment 42 is constantly biased in the rotational direction of the arrow D in FIG. 6.

The engagement segment 42 also has a slope surface 49a which extends from the tip end of the trunk portion 49 in the direction of the arrow D and in the traveling direction of the engagement pin 11. The extending end of the slope surface 49a has the hook-shaped engaging portion 48. Furthermore, the engagement segment 42 has the contact portion 51 disposed opposite to the slope surface 49a across the fulcrum portion 50. The contact portion 51 in contact with the rotatable segment 43 regulates the rotating range of the engagement segment 42 in the direction of the arrow D in FIG. 6. When the engagement segment 42 is rotated in the direction of the arrow D, the engaging portion 48 engages with the engagement pin 11 so that the disc tray 5 is held within the device body 7. When the engagement segment 42 is rotated in the opposite direction of the arrow D, the engaging portion 48 disengages from the engagement pin 11, whereby the disc tray 5 can be ejected from the device body 7 by the coil spring 28 and the pushing member 30.

The rotatable segment 43 that regulates the rotating range of the engagement segment 42 includes a regulating projected portion 55 that applies a pushing force to the contact portion 51 of the engagement segment 42 to regulate the rotating range of the engagement segment 42, a fulcrum portion 56 serving as a fulcrum for the rotatable segment 43, a contact portion 57 which is in contact with the pushing segment 46 to receive a pushing force therefrom, and a connection portion 58 connected to the plunger 45.

The rotatable segment 43 is rotatable about the fulcrum portion 56 in the direction indicated by an arrow E in FIG. 6 or in the opposite direction of the arrow E. Moreover, a torsion spring 59 is wound around the fulcrum portion 56 such that the rotatable segment 43 is constantly biased in the rotational direction of the arrow E in FIG. 6.

Because the engagement segment 42 is biased in the direction of the arrow D in FIG. 6, the regulating projected portion 55 is constantly in contact with the contact portion 51. When the rotatable segment 43 rotates in the direction of the arrow E or in the opposite direction of the arrow E, the regulating projected portion 55 regulates the rotating range of the engagement segment 42 through the contact portion 51.

The contact portion 57 has a bulge section 60 at a position where the contact portion 57 comes into contact with the pushing segment 46. When the pushing segment 46 pushes the bulge section 60, the rotatable segment 43 rotates in the opposite direction of the arrow E.

The connection portion 58 connected to the plunger 45 has a projection 58a on one surface thereof. The projection 58a extends through a connection hole 45a of the plunger 45. When the pushing segment 46 rotates the rotatable segment 43 in the opposite direction of the arrow E, the connection portion 58 moves the plunger 45 towards the iron-core coil 44. Subsequently, when the plunger 45 is held within the iron-core coil 44, the rotatable segment 43 is maintained in the opposite direction of the arrow E.

Furthermore, the contact portion 57 and the connection portion 58 have a slit 61 therebetween. The slit 61 allows the contact portion 57 pushed by the pushing segment 46 to be elastically displaceable. Accordingly, the rotatable segment 43 has the bulge section 60 in the contact portion 57 to ensure that the rotatable segment 43 can be properly rotated by the pushing segment 46 so that the plunger 45 can be properly held within the iron-core coil 44. In addition, the rotatable segment 43 is also provided with the slit 61 so that when the contact portion 57 receives an excessive pushing force from the pushing segment 46, the slit 61 can allow the contact portion 57 to bend to absorb the pushing force.

Since the rotatable segment 43 is biased in the direction of the arrow E in FIG. 6 by the torsion spring 59, the regulating projected portion 55 that is in contact with the contact portion 51 of the engagement segment 42 rotates in the direction of the arrow E while the engagement segment 42 rotates in the opposite direction of the arrow D. Consequently, the engaging portion 48 of the engagement segment 42 disengages from the engagement pin 11 in the lower half component 9 of the device body 7, whereby the disc tray 5 is ejected from the device body 7.

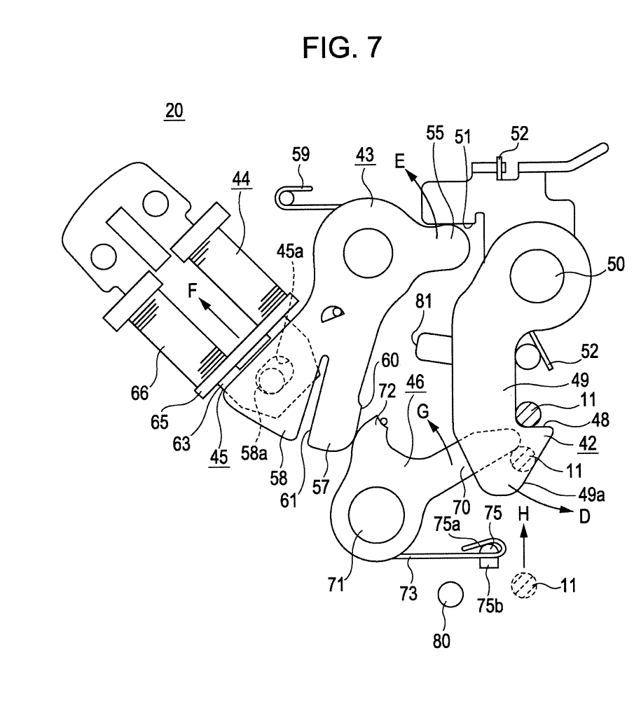

On the other hand, when the disc tray 5 is inserted into the device body 7, the contact portion 57 rotates in the opposite direction of the arrow E in response to a pushing force of the pushing segment 46 so as to allow the plunger 45 connected to the connection portion 58 to be held within the iron-core coil 44. As a result, the regulating projected portion 55 of the rotatable segment 43 rotates in the opposite direction of the arrow E, while the engagement segment 42 rotates in the direction of the arrow D as shown in FIG. 7. Thus, the engaging portion 48 of the engagement segment 42 engages with the engagement pin 11, whereby the disc tray 5 is held within the device body 7.

The plunger 45 that maintains the rotatable segment 43 in the opposite direction of the arrow E is formed of a substantially U-shaped magnetic body and has a pair of insertion shafts 63 that can be inserted into the iron-core coil 44. The plunger 45 also has the connection hole 45a in a base-end portion thereof. The projection 58a provided in the connection portion 58 of the rotatable segment 43 extends through this connection hole 45a, whereby the rotatable segment 43 and the plunger 45 are connected to each other.

The iron-core coil 44 having the insertion shafts 63 of the plunger 45 extending therethrough includes a hollow iron core 65 around which a coil 66 is wound. The insertion shafts 63 extend through the hollow section of the iron core 65. Furthermore, the iron-core coil 44 contains a magnet (not shown) at a side opposite to the inserting ends of the insertion shafts 63. This magnet magnetically attracts the insertion shafts 63 in the direction indicated by an arrow F in FIG. 6. When the rotatable segment 43 is rotated in the opposite direction of the arrow E until the insertion shafts 63 of the plunger 45 are inserted deep in the iron-core coil 44, the magnet holds the insertion shafts 63 within the iron-core coil 44, as shown in FIG. 7. On the other hand, when an electric current is supplied to the coil 66, the iron-core coil 44 cancels the magnetic force of the magnet, which had been magnetically attracting the insertion shafts 63, so as to set the plunger 45 in a free state. By setting the plunger 45 in a free state, the rotatable segment 43 becomes rotatable in the direction of the arrow E due to the bias force of the torsion spring 59.

The pushing segment 46 that comes into contact with the contact portion 57 of the rotatable segment 43 to push against the rotatable segment 43 includes an arm portion 70 to be pushed by the engagement pin 11 provided in the device body 7, a fulcrum portion 71 disposed in the base-end portion of the arm portion 70 and serving as a fulcrum for the pushing segment 46, and a pushing portion 72 for pushing the contact portion 57 of the rotatable segment 43 to rotate the rotatable segment 43.

The pushing segment 46 is rotatable about the fulcrum portion 71 in the direction indicated by an arrow G in FIG. 6 or in the opposite direction of the arrow G. Moreover, a torsion spring 73 is wound around the fulcrum portion 71 such that the arm portion 70 is maintained at a position shown in FIG. 6, at which the arm portion 70 intersects with the traveling path of the engagement pin 11. In other words, after the arm portion 70 rotates in the direction of the arrow G in response to a pushing force from the engagement pin 11 such as to rotate the rotatable segment 43 in the opposite direction of the arrow E or after the pushing segment 46 rotates in the opposite direction of the arrow G by coming into contact with the contact portion 57 in response to a rotation of the rotatable segment 43 in the direction of the arrow E, the torsion spring 73 can return the pushing segment 46 back to its original position.

The torsion spring 73 provided for a positional regulation of the pushing segment 46 and wound around the fulcrum portion 71 has its first end secured to the pushing segment 46 and its second end secured to a securing member 75 disposed on the undersurface 5c of the disc tray 5. The securing member 75 includes a semicircular securing segment 75a and a rectangular securing segment 75b which are separated from each other by a certain clearance gap. The torsion spring 73 is secured to the securing member 75 by inserting the second end of the torsion spring 73 through the clearance gap and then hooking the second end onto the semicircular securing segment 75a. In this case, since the securing segment 75b is given a rectangular shape in contrast to the semicircular shape of the securing segment 75a, it is difficult to wind the torsion spring 73 around the securing segment 75b. Therefore, the torsion spring 73 is preferably hooked onto the semicircular securing segment 75a. Accordingly, the torsion spring 73 applies an optimal bias force to the pushing segment 46 so that even when the pushing segment 46 rotates in the direction of the arrow G or the opposite direction of the arrow G in response to a pushing force from the engagement pin 11 or the rotatable segment 43, the torsion spring 73 can return the arm portion 70 back to its original position, which is where the arm portion 70 intersects with the traveling path of the engagement pin 11.

In the vicinity of the rotating range of the arm portion 70, more specifically, at a side of the rotating range in the opposite direction of the arrow G, a stopper 80 is provided for preventing excessive rotation of the arm portion 70. The stopper 80 is defined by, for example, a columnar projection projected from the undersurface 5c of the disc tray 5. When the rotatable segment 43 rotates in the direction of the arrow E, the contact portion 57 abuts on the pushing segment 46 so as to rotate the pushing segment 46 in the opposite direction of the arrow G. In this case, as shown with a dotted line in FIG. 6, the stopper 80 regulates the rotation of the arm portion 70 and prevents the arm portion 70 from rotating excessively in the opposite direction of the arrow G. Consequently, the arm portion 70 of the pushing segment 46 is prevented from losing its capability to return to the traveling path of the engagement pin 11.

Specifically, supposing that the arm portion 70 loses its capability to return to the traveling path of the engagement pin 11, the engagement pin 11 will not be able to rotate the arm portion 70 when the disc tray 5 is being inserted into the device body 7. Thus, the pushing segment 46 will lose its capability to rotate the rotatable segment 43 in the direction of the arrow E, which implies that the engagement segment 42 will not be rotated in the direction of the arrow D for the engagement with the engagement pin 11. Accordingly, the stopper 80 provided in the pushing segment 46 for regulating the rotating range of the arm portion 70 ensures that the arm portion 70 can properly return to the traveling path of the engagement pin 11.

According to the above-described engagement mechanism 20 constituted by the engagement pin 11, the engagement segment 42, the rotatable segment 43, the plunger 45, and the pushing segment 46, the rotatable segment 43 is biased in the direction of the arrow E when the disc tray 5 is ejected from the device body 7, as shown in FIG. 6. In this state, the rotatable segment 43 is retained by a stopper wall 81 provided on the disc tray 5 such that the stopper wall 81 regulates the rotation of the rotatable segment 43 in the direction of the arrow E. On the other hand, the engagement segment 42 has its contact portion 51 rotated in the opposite direction of the arrow D by the regulating projected portion 55 of the rotatable segment 43. In this state, the engaging portion 48 is maintained at a position withdrawn from the traveling path of the engagement pin 11. Consequently, the disc tray 5 and the lower half component 9 of the device body 7 having the engagement pin 11 are disengaged from each other. In response to the bias force of the coil spring 28 included in the disc tray 5, the pushing member 30 thus applies a bias force to the back wall 9a of the lower half component 9 so as to eject the disc tray 5 from the device body 7.

When the optical disc 4 is set in the holding recess 15 of the disc tray 5 and the disc tray 5 is inserted into the device body 7 by a user, the engagement pin 11 in the lower half component 9 travels in the direction of an arrow H shown in FIG. 6. The engagement pin 11 then comes into contact with the arm portion 70 of the pushing segment 46 and rotates the arm portion 70 in the direction of the arrow G, as shown in FIG. 7. In response to the rotation of the arm portion 70, the pushing portion 72 of the pushing segment 46 pushes against the contact portion 57 of the rotatable segment 43, thereby rotating the rotatable segment 43 in the opposite direction of the arrow E in FIG. 7. Subsequently, the insertion shafts 63 of the plunger 45 connected to the connection portion 58 of the rotatable segment 43 are inserted deep into the iron-core coil 44 so as to be magnetically attracted to the magnet disposed within the iron-core coil 44.

In this case, since the contact portion 57 in contact with the pushing portion 72 of the pushing segment 46 has the bulge section 60, the pushing segment 46 can push against the bulge section 60 to ensure that the rotatable segment 43 is properly rotated in the opposite direction of the arrow E, whereby the plunger 45 can be magnetically attracted to the magnet contained in the iron-core coil 44. Furthermore, due to the slit 61 provided between the contact portion 57 and the connection portion 58, the contact portion 57 of the rotatable segment 43 is made elastically displaceable. Consequently, even when the contact portion 57 receives an excessive pushing force from the pushing segment 46, the contact portion 57 can bend to absorb the pushing force.

Accordingly, the plunger 45 and the rotatable segment 43 are rotated and maintained in the opposite direction of the arrow E in FIG. 7 against the bias force of the torsion spring 59 acting in the direction of the arrow E. Since the regulating projected portion 55 of the rotatable segment 43 is rotated in the opposite direction of the arrow E, the rotating range of the engagement segment 42 broadens in the direction of the arrow D. Consequently, due to the bias force of the torsion spring 52 in the direction of the arrow D in FIG. 7, the engaging portion 48 is positioned on the traveling path of the engagement pin 11 as shown in FIG. 7.

When the disc tray 5 is inserted into the device body 7, the engagement pin 11 travels in the direction of the arrow H in FIG. 7 while rotating the slope surface 49a, which extends from the tip end of the trunk portion 49 of the engagement segment 42, in the opposite direction of the arrow D. The engagement pin 11 travels in the direction of the arrow H until it engages with the engaging portion 48. As a result, the disc tray 5 and the lower half component 9 of the device body 7 engage with each other.

In this case, referring to FIG. 5, the pushing member 30 is pushed back by the back wall 9a of the lower half component 9 such that the pushing member 30 moves toward the front face 5a while the flange 30a of the pushing member 30 compresses the coil spring 28 towards the front face 5a. Since the end of the coil spring 28 proximate to the front face 5a is retained by the corresponding container wall 29a of the spring container 29, the coil spring 28 is compressed due to the pushing force of the flange 30a. Thus, the coil spring 28 is in a state where it maintains a bias force for biasing the flange 30a towards the back face 5d. In other words, the disc tray 5 is held within the device body 7 by having the engagement segment 42 engaged with the engagement pin 11 in the lower half component 9 while the lower half component 9 applies a bias force towards the back face 5d.

As described above, the recording/reproducing device 1 is configured such that the depressed portion 33 of the opening 31 and the flange portion 34 of the engagement pin 11 are given sufficient diameters so that the contact area therebetween is sufficient for attaining the desired resistance to dropping impact. In addition, the opening 31 is disposed at a position that is separated from the sidewall 9c by a preferred distance, and moreover, the engagement projection 36 of the engagement pin 11 is disposed on the pin body 35 at a position biased towards the sidewall 9c in correspondence to the engagement segment 42. Consequently, in the recording/reproducing device 1, the depressed portion 33 and the flange portion 34 are given enlarged diameters to improve the resistance to dropping impact while a preferred distance is maintained between the engagement pin 11 and the sidewall 9c. In addition, the engagement projection 36 is allowed to project from a position that corresponds to the engagement segment 42, which is subject to positional restriction.

Accordingly, when the recording/reproducing device 1 is being carried in a state where the disc tray 5 is held within the device body 7, even if the recording/reproducing device 1 is accidentally dropped and thus receives an impact, the engagement pin 11 is prevented from tilting.

When the disc tray 5 is to be ejected from the device body 7, the control circuit supplies an electric current to the iron-core coil 44 in response to an operation signal received from an operating portion of the disc tray 5. This cancels the magnetic force of the magnet contained within the iron-core coil 44, thereby setting the plunger 45 in a free state. Accordingly, the rotatable segment 43 rotates in the direction of the arrow E in FIG. 6 due to the bias force of the torsion spring 59, meaning that the regulating projected portion 55 rotates in the direction of the arrow E. In response to this rotation of the regulating projected portion 55, the engagement segment 42 rotates in the opposite direction of the arrow D, whereby the engaging portion 48 withdraws from the traveling path of the engagement pin 11. As a result, the engaging portion 48 disengages from the engagement pin 11, whereby the disc tray 5 disengages from the lower half component 9 of the device body 7.

In this case, the pushing member 30 whose tip end abuts on the back wall 9a of the lower half component 9 receives a reactive force from the back wall 9a, which is equal to the bias force of the coil spring 28. Due to this reactive force, the flange 30a pushes back the coil spring 28 towards the front face 5a. Since the end of the coil spring 28 proximate to the front face 5a is retained by the corresponding container wall 29a of the spring container 29, the coil spring 28 expands while pushing the container wall 29a towards the front face 5a. Thus, the disc tray 5 is pushed towards the open end of the device body 7 until the front face 5a protrudes outward from the open end of the device body 7.

In addition, when the rotatable segment 43 rotates in the direction of the arrow E, the contact portion 57 of the rotatable segment 43 abuts on the pushing portion 72 of the pushing segment 46 so as to rotate the pushing segment 46 in the opposite direction of the arrow G. In this case, since the stopper 80 regulates the rotation of the arm portion 70, an excessive rotation of the arm portion 70 is prevented from occurring, thereby preventing a situation where the arm portion 70 loses its capability to return to the traveling path of the engagement pin 11. Furthermore, the securing position for the torsion spring 73 wound around the pushing segment 46 is restricted to an appropriate position by the securing member 75 disposed on the undersurface 5c of the disc tray 5, such that the torsion spring 73 can apply an optimal bias force to the pushing segment 46. Accordingly, even when the pushing segment 46 is rotated in the direction of the arrow G or the opposite direction of the arrow G in response to a pushing force of the engagement pin 11 or the rotatable segment 43, the arm portion 70 can return to its original position, which is where the arm portion 70 intersects with the traveling path of the engagement pin 11, as shown with a solid line in FIG. 6.

Although the bulge section 60 is provided in the contact portion 57 of the rotatable segment 43 in the above configuration, the bulge section 60 may alternatively be provided in the pushing portion 72 of the pushing segment 46. As a further alternative, the bulge section 60 may be provided in each of the rotatable segment 43 and the pushing segment 46.

The optical pickup unit 6 mounted within the storage portion 21 provided on the undersurface 5c of the disc tray 5 will now be described.

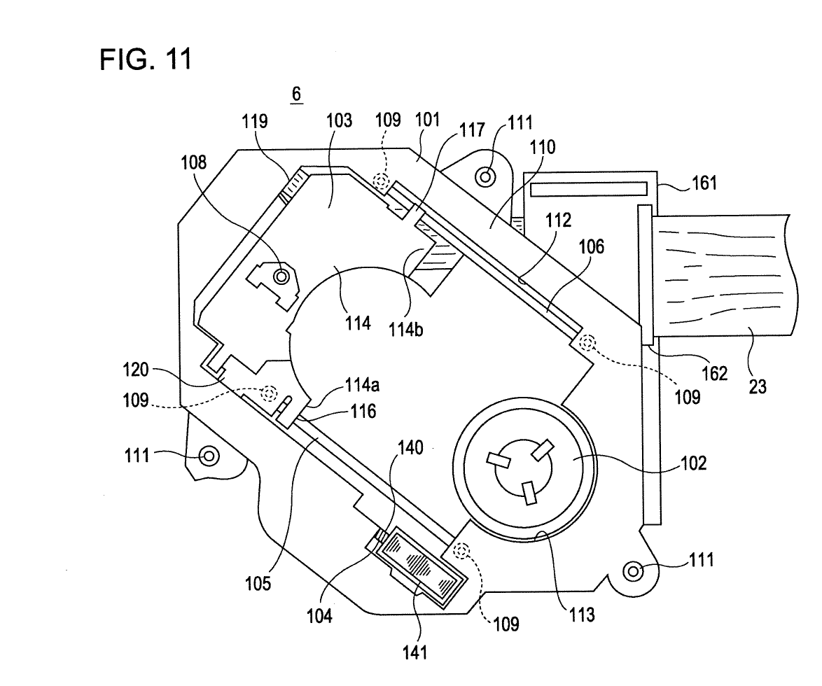

Referring to FIG. 11, the optical pickup unit 6 includes the base chassis 101 that constitutes a unit body, the disc table 102 which is integrated with the base chassis 101 and on which the optical disc 4 can be set, an optical pickup element 103 which records an information signal onto or reproduces an information signal from the optical disc 4 set on the disc table 102, a pickup moving mechanism 104 which moves the optical pickup element 103 in the radial direction of the optical disc 4, a pair of guide shafts 105, 106 for guiding the optical pickup element 103 moved by the pickup moving mechanism 104, and a skew adjusting mechanism 109 which adjusts the tilt angle of the guide shafts 105, 106 so as to adjust a relative skew between the objective lens 108 included in the optical pickup element 103 and a signal recording face of the optical disc 4.

The base chassis 101 includes a substantially rectangular iron frame 110. The frame 110 has an aperture 112 through which the objective lens 108 of the optical pickup element 103 faces the signal recording face of the optical disc 4. The aperture 112 is substantially rectangular and holds therein the pickup moving mechanism 104 that moves the optical pickup element 103 in the longitudinal direction of the rectangular aperture 112, the pair of guide shafts 105, 106, and the optical pickup element 103 supported by the guide shafts 105, 106. Furthermore, the aperture 112 has a cutout 113 at one longitudinal end thereof, which has a substantially arc shape. The cutout 113 holds therein the circular disc table 102 on which the optical disc 4 can be set and a spindle motor (not shown) for rotating the disc table 102.

The frame 110 has the plurality of engagement holes 111 that allow the base chassis 101 to be engageable with the plurality of engagement protrusions 25 provided within the storage portion 21 disposed on the undersurface 5c of the disc tray 5. The frame 110 is stored within the storage portion 21 by engaging the engagement holes 111 with the corresponding engagement protrusions 25.

The optical pickup element 103 that records an information signal onto or reproduces an information signal from the optical disc 4 set on the disc table 102 includes a pickup base 114 formed of a substantially rectangular housing. The pickup base 114 holds at least a light source (not shown), such as a semiconductor laser, the objective lens 108 which focuses a light beam released from the light source onto the signal recording face of the optical disc 4, an optical detector (not shown) for detecting light reflected by and returning from the recording face of the optical disc 4, and a driving system for driving the objective lens 108 in the focusing and tracking directions of the optical disc 4. Furthermore, in the optical pickup element 103, the pickup base 114 has a first longitudinal end 114a having an insertion hole 116 through which the guide shaft 105 extends and a second longitudinal end 114b having an engagement segment 117 that engages with the guide shaft 106. The pickup base 114 has a flexible wiring substrate 119 attached thereto, which has, for example, a drive circuit that controls the driving system for the objective lens 108.

The optical pickup element 103 is disposed adjacent to the guide shaft 105 and has an engagement member 120 that is engaged with a lead screw 140 included in the pickup moving mechanism 104 for moving the pickup base 114.

The optical pickup element 103 is supported by the pair of guide shafts 105, 106 that are disposed on opposite sides of the aperture 112 of the base chassis 101. Thus, the guide shafts 105, 106 guide the optical pickup element 103 between the inner and outer peripheries of the optical disc 4 while allowing the objective lens 108 to face the recording face of the optical disc 4 through the aperture 112.

The guide shafts 105, 106 guiding the optical pickup element 103 are opposed to each other across the aperture 112 of the base chassis 101. The opposite ends of each of the guide shafts 105, 106 are made narrower than the trunk portion thereof and are given a width of, for example, about 1.2 mm. These opposite ends are supported by the skew adjusting mechanism 109 which adjusts the tilt angle of the guide shafts 105, 106 in the vertical direction. The guide shafts 105, 106 are composed of a conductive material, and adjustment screws of the same conductive material are grounded such as to eliminate the electric charge on the guide shafts 105, 106.

Referring to FIG. 11, the pickup moving mechanism 104, which is disposed adjacent to the guide shaft 105 and moves the optical pickup element 103 in the radial direction of the optical disc 4, includes the lead screw 140 and a feed motor 141. The lead screw 140 is disposed adjacent and parallel to the guide shaft 105 and is attached to the base chassis 101 such as to extend in the radial direction of the optical disc 4. The feed motor 141 is provided for rotating the lead screw 140.

The lead screw 140 has a thread groove in the shaft portion thereof, and the engagement member 120 in the pickup base 114 is slidably engaged with this thread groove. By rotating the lead screw 140 with the feed motor 141, the pickup base 114 can be moved in the radial direction of the optical disc 4 via the engagement member 120.

The feed motor 141 that rotates the lead screw 140 is a direct-current motor and functions as a stepping motor. The feed motor 141 rotates the lead screw 140 in a step-feed fashion based on a rectangular wave so as to move the pickup base 114 in the radial direction of the optical disc 4.

Referring to FIG. 11, the base chassis 101 is connected to a wiring substrate 161 that has a drive circuit. The wiring substrate 161 is a so-called rigid substrate provided with a wiring pattern and having mounted thereon various types of electronic parts, such as a connector 162 which is connected to the FPC 23 attached to the wiring substrate 17 in the lower half component 9 of the device body 7.

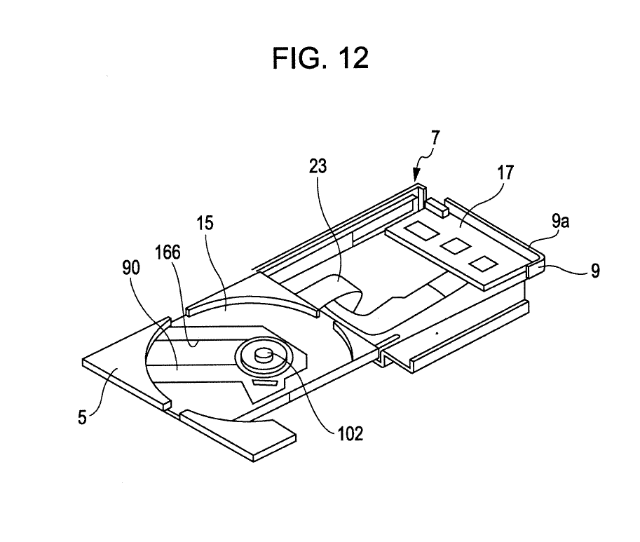

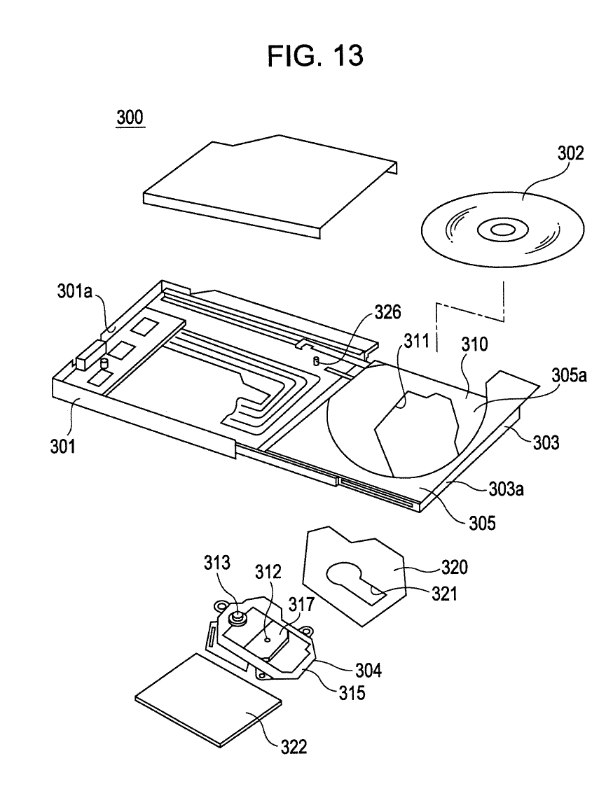

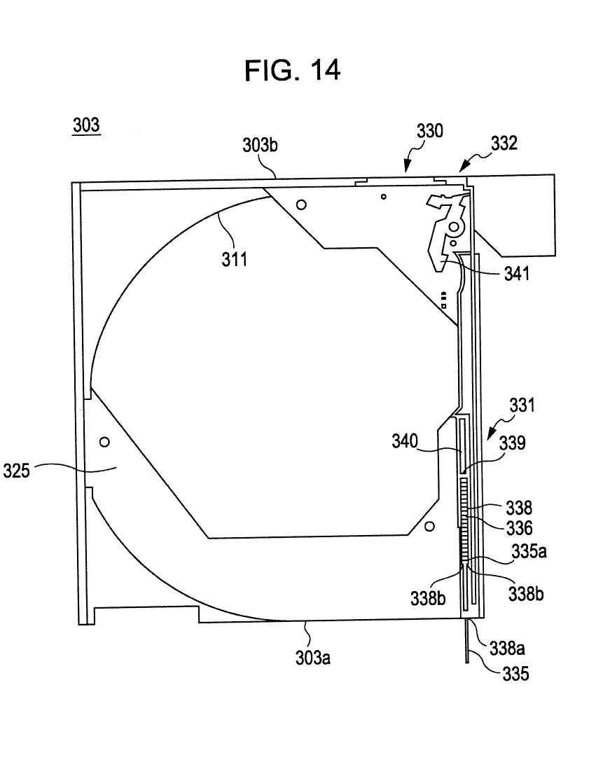

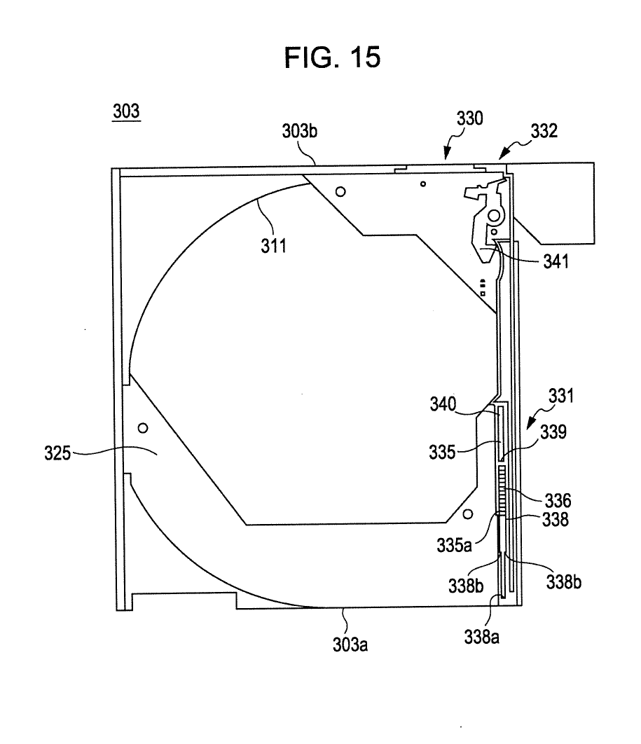

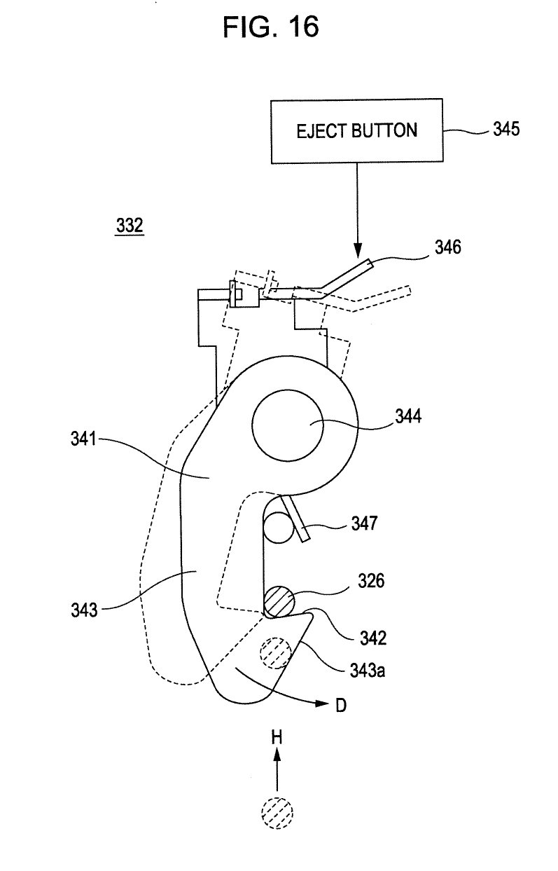

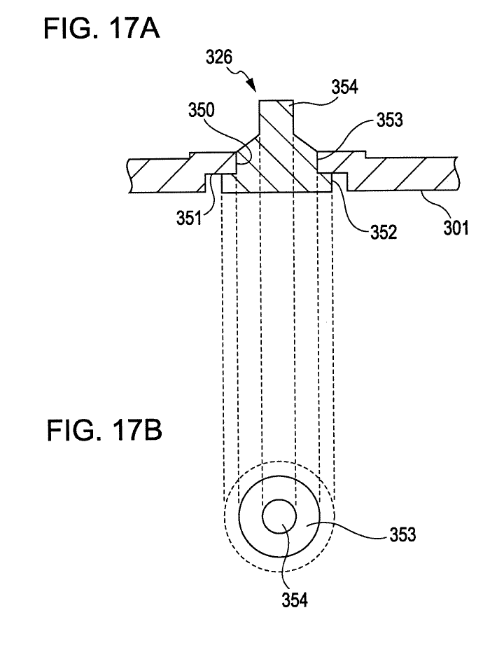

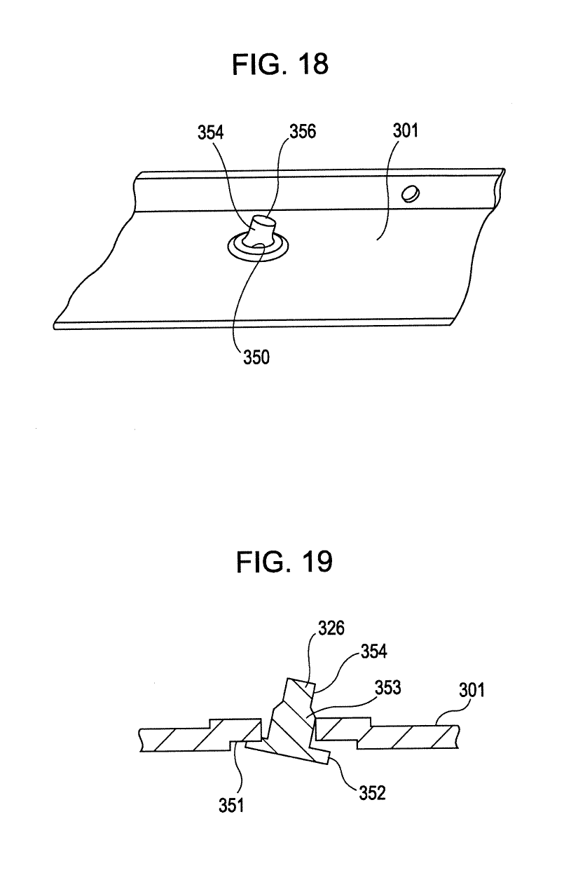

Referring to FIGS. 2 and 12, the optical pickup unit 6 described above has the cover member 90 screwed on the top surface of the base chassis 101 and a bottom plate 91 screwed to the disc tray 5 at the bottom side of the base chassis 101. Accordingly, the optical pickup unit 6 is sandwiched between the cover member 90 and the bottom plate 91.

The cover member 90 has an aperture 166 through which the objective lens 108 in the optical pickup element 103 and the disc table 102 face upward. The cover member 90 is screwed on the top surface of the base chassis 101 in a manner such that the disc table 102 and the objective lens 108 of the pickup base 114 can face upward through the aperture 166.

The bottom plate 91 is formed by punching an aluminum plate-like material into a predetermined shape. The bottom plate 91 has predetermined screw holes used for screwing the bottom plate 91 to the storage portion 21 of the disc tray 5 from the bottom side of the base chassis 101 stored within the storage portion 21. Thus, the bottom plate 91 and the disc tray 5 are joined to each other with the base chassis 101 sandwiched therebetween.

The inserting and ejecting operations of the disc tray 5 in the recording/reproducing device 1 will now be described.

In the recording/reproducing device 1, the skew adjusting mechanism 109 supporting the opposite ends of the guide shafts 105, 106 adjusts the tilt angle of these guide shafts 105, 106 so that a light beam exiting the objective lens 108 can orthogonally enter the signal recording face of the optical disc 4.

In order to set the optical disc 4 on the disc tray 5, the recording/reproducing device 1 first ejects the disc tray 5 outward from the device body 7. To describe this in detail with reference to FIG. 6, in the device body 7, the rotatable segment 43 is biased in the direction of the arrow E such as to be in contact with the stopper wall 81 provided in the disc tray 5. Moreover, the contact portion 51 of the engagement segment 42 is rotated by the regulating projected portion 55 of the rotatable segment 43 in the opposite direction of the arrow D, whereby the engaging portion 48 is maintained at a position withdrawn from the traveling path of the engagement pin 11. Consequently, the disc tray 5 and the lower half component 9 of the device body 7 having the engagement pin 11 are disengaged from each other. In response to the bias force of the coil spring 28 included in the disc tray 5, the pushing member 30 thus applies a bias force to the back wall 9a of the lower half component 9 so as to eject the disc tray 5 from the device body 7.

When the optical disc 4 is set in the holding recess 15 of the disc tray 5 and the disc tray 5 is inserted into the device body 7 by a user, the engagement pin 11 in the lower half component 9 travels in the direction of the arrow H in FIG. 6. The engagement pin 11 then comes into contact with the arm portion 70 of the pushing segment 46 and rotates the arm portion 70 in the direction of the arrow G, as shown in FIG. 7. In response to the rotation of the arm portion 70, the pushing portion 72 of the pushing segment 46 pushes against the contact portion 57 of the rotatable segment 43, thereby rotating the rotatable segment 43 in the opposite direction of the arrow E in FIG. 7. Subsequently, the insertion shafts 63 of the plunger 45 connected to the connection portion 58 of the rotatable segment 43 are inserted deep into the iron-core coil 44 so as to be magnetically attracted to the magnet disposed within the iron-core coil 44.

In this case, since the contact portion 57 in contact with the pushing portion 72 of the pushing segment 46 has the bulge section 60, the pushing segment 46 can push against the bulge section 60 to ensure that the rotatable segment 43 is properly rotated in the opposite direction of the arrow E, whereby the plunger 45 can be magnetically attracted to the magnet contained in the iron-core coil 44. Furthermore, due to the slit 61 provided between the contact portion 57 and the connection portion 58, the contact portion 57 of the rotatable segment 43 is made elastically displaceable. Consequently, even when the contact portion 57 receives an excessive pushing force from the pushing segment 46, the contact portion 57 can bend to absorb the pushing force.

Accordingly, the plunger 45 and the rotatable segment 43 are rotated and maintained in the opposite direction of the arrow E in FIG. 7 against the bias force of the torsion spring 59. Since the regulating projected portion 55 of the rotatable segment 43 is rotated in the opposite direction of the arrow E, the rotating range of the engagement segment 42 broadens in the direction of the arrow D. Consequently, the engaging portion 48 is positioned on the traveling path of the engagement pin 11 as shown in FIG. 7.

When the disc tray 5 is inserted into the device body 7, the engagement pin 11 travels in the direction of the arrow H in FIG. 7 while rotating the slope surface 49a, which extends from the tip end of the trunk portion 49 of the engagement segment 42, in the opposite direction of the arrow D. The engagement pin 11 travels in the direction of the arrow H until it engages with the engaging portion 48. As a result, the disc tray 5 and the lower half component 9 of the device body 7 engage with each other.

In this case, referring to FIG. 5, the pushing member 30 is pushed back by the back wall 9a of the lower half component 9 such that the pushing member 30 moves toward the front face 5a while the flange 30a of the pushing member 30 compresses the coil spring 28 towards the front face 5a. Since the end of the coil spring 28 proximate to the front face 5a is retained by the corresponding container wall 29a of the spring container 29, the coil spring 28 is compressed due to the pushing force of the flange 30a. Thus, the coil spring 28 is in a state where it maintains a bias force for biasing the flange 30a towards the back face 5d. In other words, the disc tray 5 is held within the device body 7 by having the engagement segment 42 engaged with the engagement pin 11 in the lower half component 9 while the lower half component 9 applies a bias force towards the back face 5d.

An ejecting process of the optical disc 4 will be described below. When it is detected that an eject button has been pressed, the recording/reproducing device 1 supplies electricity to the iron-core coil 44 to cancel the magnetic force of the magnet that magnetically attracts the plunger 45. This allows the engagement mechanism 20 of the disc tray 5 and the engagement pin 11 of the device body 7 to disengage from each other. Then, the disc tray 5 holding the optical disc 4 is ejected outward from the device body 7 due to the bias force of the coil spring 28.

In detail, when the disc tray 5 is to be ejected from the device body 7, the control circuit supplies an electric current to the iron-core coil 44 in response to an operation signal received from the operating portion of the disc tray 5 so as to cancel the magnetic force of the magnet contained within the iron-core coil 44. Accordingly, the rotatable segment 43 rotates in the direction of the arrow E in FIG. 6 due to the bias force of the torsion spring 59, meaning that the regulating projected portion 55 rotates in the direction of the arrow E. In response to this rotation of the regulating projected portion 55, the engagement segment 42 rotates in the opposite direction of the arrow D, whereby the engaging portion 48 withdraws from the traveling path of the engagement pin 11. As a result, the engaging portion 48 disengages from the engagement pin 11, whereby the disc tray 5 disengages from the lower half component 9 of the device body 7.

In this case, the pushing member 30 receives a reactive force from the back wall 9a, which is equal to the bias force of the coil spring 28, causing the flange 30a of the pushing member 30 to push back the coil spring 28 towards the front face 5a. Since the end of the coil spring 28 proximate to the front face 5a is retained by the corresponding container wall 29a of the spring container 29, the coil spring 28 expands while pushing the container wall 29a towards the front face 5a. Thus, the disc tray 5 is pushed towards the open end of the device body 7 until the front face 5a protrudes outward from the open end of the device body 7.

In addition, when the rotatable segment 43 rotates in the direction of the arrow E, the contact portion 57 of the rotatable segment 43 abuts on the pushing portion 72 of the pushing segment 46 so as to rotate the pushing segment 46 in the opposite direction of the arrow G. In this case, since the stopper 80 regulates the rotation of the arm portion 70, an excessive rotation of the arm portion 70 is prevented from occurring, thereby preventing a situation where the arm portion 70 loses its capability to return to the traveling path of the engagement pin 11. Furthermore, the securing position for the torsion spring 73 wound around the pushing segment 46 is restricted to an appropriate position by the securing member 75 disposed on the undersurface 5c of the disc tray 5, such that the torsion spring 73 can apply an optimal bias force to the pushing segment 46. Accordingly, even when the pushing segment 46 is rotated in the direction of the arrow G or the opposite direction of the arrow G in response to a pushing force of the engagement pin 11 or the rotatable segment 43, the arm portion 70 can return to its original position, which is where the arm portion 70 intersects with the traveling path of the engagement pin 11.

In the course of the ejecting process of the optical disc 4, there may be a case where the optical disc 4 held on the disc tray 5 becomes loose in response to vibration. The amount of displacement of the optical disc 4 due to such looseness is greater towards the outer periphery thereof than the inner periphery. For this reason, the optical pickup element 103 in the recording/reproducing device 1 is positioned closer to the inner periphery of the optical disc 4 so as to prevent damages caused as a result of contact between the optical disc 4 and the objective lens 108 of the optical pickup element 103.

Although the recording/reproducing device according to the embodiment of the present invention has been described above, the present invention permits an alternative embodiment in which the recording/reproducing device is applicable to other types of optical discs, such as a CD (compact disc), CD-ROM, CD-R/RW, DVD-ROM, and DVD-RAM.

Furthermore, the host apparatus in which the recording/reproducing device according to the above embodiment is installed may be, for example, a portable recording/reproducing apparatus, such as a notebook-size personal computer and a PDA (personal digital assistant), or a stationary recording/reproducing apparatus, such as a desktop personal computer and a server, or an in-vehicle recording/reproducing apparatus.

The dimensions given to the recording/reproducing device in the above embodiment of the present invention are only exemplary, and the present invention permits an alternative embodiment in which different dimensions are given.

It should be understood by those skilled in the art that various modifications, combinations, sub-combinations and alterations may occur depending on design requirements and other factors insofar as they are within the scope of the appended claims or the equivalents thereof.

What is claimed is:

1. A recording and/or reproducing device comprising:
a disc tray on which a recording medium is set;
a device body that supports the disc tray in a manner such that the disc tray is movable into and out of the device body; and
a disc-tray holding mechanism for holding the disc tray within the device body,
wherein the disc-tray holding mechanism includes
a bias member for biasing the disc tray outward of the device body,
an engagement pin extending through an opening of the device body near a sidewall of the device body, the engagement pin being engageable with the disc tray such as to hold the disc tray within the device body, and
an engagement segment provided in the disc tray, the engagement segment engaging with the engagement pin when the disc tray is inserted into the device body against a bias force of the bias member,
wherein the engagement pin includes a flange portion which is fitted to a depressed portion extending along an inner periphery of the opening, a pin body that extends through the opening, and an engagement projection which is projected from the pin body towards the inside of the device body and is engageable with the engagement segment, and
wherein the engagement projection is disposed on the pin body at a position biased towards the sidewall of the device body.

2. The recording and/or reproducing device according to claim 1, wherein the depressed portion and the flange portion have a contact area therebetween that gives the engagement pin engaged with the engagement segment a sufficient resistance to an impact generated when the device body is dropped.

3. The recording and/or reproducing device according to claim 1, wherein the pin body and the opening are substantially circular and the engagement projection is columnar, and wherein the columnar engagement projection is disposed on the substantially circular pin body at a position biased towards the sidewall of the device body.

4. The recording and/or reproducing device according to claim 1, wherein the pin body and the opening are substantially D-shaped such that a cutaway side of the D-shape is proximate to the sidewall of the device body, and wherein the engagement projection is disposed on the D-shaped pin body at a position biased towards the cutaway side of the D-shaped pin body.

5. The recording and/or reproducing device according to claim 1, wherein the disc-tray holding mechanism further includes
a rotatable segment which regulates a rotating range of the engagement segment by being in contact with the engagement segment such as to allow the engagement segment to engage with the engagement projection or to allow the engagement segment to disengage from the engagement projection,
a plunger which is engaged with the rotatable segment, the plunger being inserted into a magnetic coil so as to rotate the rotatable segment, and
a pushing segment which comes into contact with the rotatable segment in response to a pushing force from the engagement projection such as to push the rotatable segment in a direction for engaging the engagement segment with the engagement projection,
wherein when the disc tray is inserted into the device body against the bias force of the bias member, the engagement projection pushes against the pushing segment so that the rotatable segment in contact with the pushing segment rotates the engagement segment in the direction for engaging the engagement segment with the engagement projection, the engagement between the engagement segment and the engagement projection holding the disc tray within the device body, and wherein when the disc tray is to be ejected from the device body, the plunger rotates the rotatable segment such as to bias the engagement segment in a direction for disengaging the engagement segment from the engagement projection, the disc tray being ejected from the device body due to the bias force of the bias member.
